(19) United States
(12) Patent Application Publication
(10) Pub. No.: US 2011/0286356 A1
(43) Pub. Date: Nov. 24, 2011

(54) BROADCAST CONTROL OF ACCESS TERMINAL RADIO EVENT HANDLING

(75) Inventors: Nathan Edward Tenny, Poway, CA (US); Parag Arun Agashe, San Diego, CA (US); Fatih Ulupinar, San Diego, CA (US)

(73) Assignee: QUALCOMM INCORPORATED, San Diego, CA (US)

(21) Appl. No.: 12/949,996

(22) Filed: Nov. 19, 2010

Related U.S. Application Data
(60) Provisional application No. 61/263,756, filed on Nov. 23, 2009.

(51) Int. Cl. H04W 16/00

(52) U.S. Cl. 370/254

(57) ABSTRACT

Radio event handling at access terminals is controlled at a granularity other than access terminal-level granularity through the use of broadcast control values. For example, a network entity such as an access point may broadcast control values to control radio event handling (e.g., radio event logging and/or reporting) at access terminals in the vicinity of the access point.

### CLAIM OF PRIORITY

This application claims the benefit of and priority to commonly owned U.S. Provisional Patent Application No. 61/263,756, filed Nov. 23, 2009, and assigned Attorney Docket No. 100438P1, the disclosure of which is hereby incorporated by reference herein.

### CROSS-REFERENCE TO RELATED APPLICATION

This application is related to concurrently filed and commonly owned U.S. patent application Ser. No. ______, entitled “PROVIDING CONFIGURATION INFORMATION FOR BROADCAST CONTROL OF ACCESS TERMINAL RADIO EVENT HANDLING,” and assigned Attorney Docket No. 100438U2, the disclosure of which is hereby incorporated by reference herein.

### BACKGROUND

1. Field

This application relates generally to wireless communication and more specifically, but not exclusively, to improving radio event handling.

2. Introduction

A wireless communication network may be deployed over a geographical area to provide various types of services (e.g., voice, data, multimedia services, etc.) to users within that geographical area. In a typical implementation, access points (e.g., providing service via one or more cells) are distributed throughout a network to provide wireless connectivity for access terminals (e.g., cell phones) that are operating within the geographical area served by the network.

A network operator may periodically conduct network tests in an attempt to ensure that network resources (e.g., access points, transmit power, frequency allocation, etc.) are deployed in an efficient manner throughout the network. For example, the network operator may wish to identify problem areas where resources are under-allocated (e.g., areas of poor coverage) and identify areas where resources are over-allocated (e.g., areas where coverage is stronger than necessary or duplicative).

One technique for conducting such a network test is through the use of a drive test. Here, a vehicle equipped with wireless equipment drives to various locations within the geographical area served by the network and analyzes signal conditions at those locations. In practice, however, drive tests are a relatively expensive and time consuming.

To reduce the need for drive tests, a so-called minimization of drive tests (MDT) network test procedure has been developed. Here, access terminals (e.g., UEs, mobile stations, etc.) in the network are configured to log certain events and report these logged events to an upper-layer server (e.g., an MDT server) in the network. The goal here is that the server will collect and correlate the access terminal event reports to support network analysis.

Conventionally, the communication between the MDT server and the access terminals takes place in an end-to-end fashion at a high level (i.e., essentially as an application). Accordingly, the communication between the MDT server and the access terminal is generally not visible to the network components between the MDT server and the access terminals. Thus, reporting granularity is limited to the access terminal-level.

Going forward, location-based reporting (e.g., geographic location or logical location) has been identified by 3GPP as an important use case for MDT. However, given the current access terminal-level granularity provided by conventional MDT reporting, there is no mechanism defined for controlling network test functionality at some other granularity (e.g., location-based). Consequently, there is a need for more effective and efficient techniques for conducting testing in wireless communication networks.

### SUMMARY

A summary of several sample aspects of the disclosure follows. This summary is provided for the convenience of the reader and does not wholly define the breadth of the disclosure. For convenience, the term some aspects may be used herein to refer to a single aspect or multiple aspects of the disclosure.

The disclosure relates in some aspects to controlling radio event handling at access terminals at a granularity other than access terminal-level granularity. This is achieved in some aspects by broadcasting control values in order to control radio event handling at any access terminals that receive these broadcast control values. For example, a network entity such as an access point may broadcast control values to control radio event handling at access terminals that are camping on or otherwise served by the access point. In this way, radio event logging and reporting functions may be enabled, disabled, and otherwise controlled at the access point-level.

The disclosed radio event handling scheme may be advantageously employed, for example, if there is a suspected network problem in the vicinity of a particular cell or access point. In such a case, network analysis may be simplified since a more appropriate level of granularity is provided for obtaining reports from access terminal. For example, a single command from an MDT server may invoke the desired level of reporting. Thus, in some aspects, the disclosure relates to per-access point control of measurement and reporting functionality that may be managed at the application layer.

Moreover, the MDT server may perform network analysis at a desired granularity level (e.g., access point-level) without having to maintain information concerning which access terminals are associated with a given access point. In contrast, in a conventional MDT scheme where access terminals are controlled on an individual basis, to control the access terminals associated with a given access point, the MDT server would need to maintain information that identifies the access terminals that are associated with a given access point. This would be relatively resource intensive due, in part, to the mobility of access terminals, and does not apply well to access terminals in idle mode since their association with a given access point is not normally known to the network. Consequently, the radio event handling scheme disclosed herein may provide a more efficient mechanism for providing access point-level granularity for network analysis.

The disclosure relates in some aspects to a network entity such as, for example, a network server (e.g., an MDT server) that controls the broadcasting of radio event handling control values. Here, the network entity generates configuration information that indicates how access terminals are to perform radio event handling. The network entity then sends a message including the configuration information to at least one other network entity (e.g., at least one access point or an associated mobility management entity (MME)). This, in turn, causes the at least one access point to broadcast at least one control value based on the configuration information.

The disclosure relates in some aspects to controlling the broadcast of control values through the use of a network entity such as, for example, an MME. For example, this network entity receives a first message from another network entity (e.g., an MDT server), where the first message includes radio event handling configuration information. The network entity (e.g., the MME) then sends at least one second message to at least one access point (e.g., an eNode B) as a result of receiving the first message. Here, the at least one second message includes radio event handling information that is based on the received configuration information and thereby indicates how access terminals (e.g., UEs) that receive at least one control value broadcast by the at least one access point are to perform radio event handling.

The disclosure relates in some aspects to broadcasting control values to control radio event handling at access terminals. For example, an access point receives a message from a network entity (e.g., an MDT server or a MME), wherein the message includes radio event handling configuration information. The access point then broadcasts at least one control value as a result of receiving the configuration information, wherein the at least one control value indicates how access terminals (e.g., UEs) that receive the at least one control value are to perform radio event handling.

The disclosure relates in some aspects to controlling radio event handling based on broadcast control values that are received by an access terminal. For example, the access terminal receives a broadcast message from an access point, wherein the broadcast message includes at least one control value. Radio event handling (e.g., logging and/or reporting) at the access terminal is then controlled based on the at least one control value.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of several sample aspects of a communication system where an access point broadcasts control values to control access terminal radio event handling;

FIG. 2 is a simplified diagram of sample call flow for a communication system where an MDT server sends configuration information to access points that broadcast control values to control access terminal radio event handling;

FIG. 3 is a simplified block diagram of several sample aspects of a communication system where a server sends configuration information to mobility managers that, in turn, send configuration information to an access point that broadcasts control values to control access terminal radio event handling;

FIG. 4 is a flowchart of several sample aspects of operations that may be performed in conjunction with conducting network analysis by generating configuration information that controls the broadcast of control values that, in turn, control access terminal radio event handling;

FIG. 5 is a flowchart of several sample aspects of operations that may be performed in conjunction with a network entity sending configuration information to access points to control the broadcast of control values that, in turn, control access terminal radio event handling;

FIG. 6 is a flowchart of several sample aspects of operations that may be performed in conjunction with broadcasting control values that control access terminal radio event handling;

FIG. 7 is a flowchart of several sample aspects of operations that may be performed in conjunction with controlling radio event handling at an access terminal based on broadcast control values that are received by the access terminal;

FIG. 8 is a simplified block diagram of several sample aspects of components that may be employed in communication nodes;

FIG. 9 is a simplified block diagram of several sample aspects of communication components; and

FIGS. 10-13 are simplified block diagrams of several sample aspects of apparatuses configured to support the broadcasting of control values to control radio event handling as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

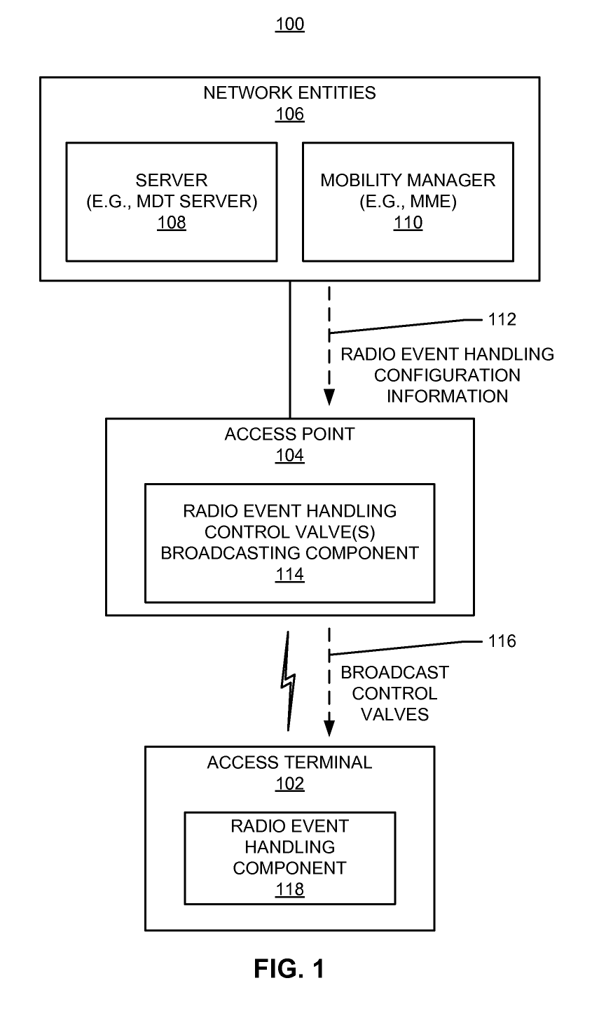

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, Node Bs, eNode Bs, and so on, while access terminals may be referred to or implemented as user equipment (UEs), mobile stations, and so on.

Access points in the system 100 provide access to one or more services (e.g., network connectivity) for one or more wireless terminals (e.g., the access terminal 102) that may be installed within or that may roam throughout a coverage area of the system 100. For example, at various points in time the access terminal 102 may connect to an access point 104 or some other access point in the system 100 (not shown). Each of these access points may communicate with one or more network entities (represented, for convenience, by network entities 106) to facilitate wide area network connectivity.

These network entities may take various forms such as, for example, one or more radio and/or core network entities. Thus, in various implementations the network entities may represent functionality such as at least one of: network management (e.g., via an operation, administration, management, and provisioning entity), call control, session management, mobility management, gateway functions, interworking functions, server functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals. Also, two of more of these network entities may be co-located and/or two or more of these network entities may be distributed throughout a network.

A network entity such as a server 108 (e.g., an MDT server) generates radio event handling configuration information to control radio event handling at access terminals in the system 100. In accordance with the teachings herein, rather than sending configuration information directly to each access terminal (e.g., via upper-layer signaling), the server 108 sends configuration information to one or more network entities to cause access points in the system to broadcast radio event handling control values that, in turn, control radio event handling at any access terminals that receive these control values. In this way, radio event handling may be controlled at an access point granularity (e.g. to diagnose network performance in the vicinity of a given cell in the network). For example, MDT-enabled access terminals in the vicinity of a particular access point may have their radio event logging and/or reporting switched on or off in response to the server 108 sending an appropriate instruction to that access point.

The configuration information is defined to control radio event handling in various ways depending on the requirements of the network analysis being employed. For example, the configuration information may specify whether an access terminal is to log radio events and/or report radio events. In addition, the configuration information may specify how an access terminal is to log radio events and/or report radio events.

The term radio event refers to various types of radio-based events that may occur at an access point. Examples of radio events include radio link failure, signal fading below a defined threshold, and call drops. Thus, radio event handling may include, for example, controlling whether a radio link failure at the access terminal is logged and/or reported, controlling whether a condition where signal fading at the access terminal is below a defined threshold is logged and/or reported, or controlling whether a call drop at the access terminal is logged and/or reported.

As mentioned above, the server 108 sends the configuration information to one or more network entities in the system 100. In some implementations, the server 108 sends the configuration information directly to one or more access points (e.g., the access point 104) that are to broadcast control values based on the configuration information. In some implementations, the server 108 sends the configuration information to one or more network entities such as a mobility manager 110 (e.g., a 3GPP mobility management entity (MME)). In this latter case, each mobility manager sends radio event handling configuration information to access points associated with that mobility manager to cause those access points to broadcast control values based on the configuration information. For example, these access points may broadcast control values that are based on settings configured at the access points by the mobility manager. Accordingly, as represented by the dashed arrow 112 in the example of FIG. 1, radio event handling configuration information is sent from one of the network entities to one or more access points (e.g., the access point 104).

A radio event handling control value(s) broadcasting component 114 of the access point 104 broadcasts at least one control value based on the received configuration information. For example, if the received configuration information indicates that access terminals are to log and report radio events, the broadcasting component 114 broadcasts at least one control value that instructs any access terminals that receive the control value(s) to commence logging and reporting radio events. The broadcasting component 114 may broadcast the control value(s) in various ways. In some implementation, control values are included in the system information broadcast by the access point 104. Accordingly, as represented by the dashed arrow 116 in the example of FIG. 1, the access point 104 broadcasts control values that may be received by any nearby access terminals (e.g., access terminal 104) that are monitoring transmissions by the access point 104.

A radio event handling component 118 of the access point 102 controls radio event handling at the access terminal 102 based on received broadcast control values. For example, if a received control value indicates that radio event logging and reporting is to be commenced, the radio event handling component 118 will commence these operations.

The configuration information and control values employed in accordance with the teachings herein may take various forms. In some implementations, the system information broadcast by an access point may comprise one or more control values (e.g., control bits) as taught herein.

In a relatively simple implementation, the controls bits may comprise a single flag (e.g., a Boolean flag) with the semantics “do log” or “don't log”. In such a case, it may be assumed that logged events are always reported immediately (i.e., logging and reporting are coupled).

In other implementations, logging and reporting may be decoupled. For example, a “do/don't log” flag and a “do/don't report” flag may be included in the system information. This separation may be useful, for example, if only certain access points have appropriate connections to the server and logged events should be stored for delivery through those access points.

Within logging, reporting, or both, different events may have separate flags. For example, access terminals in one cell might only report radio link failures, while access terminals in another cell may be instructed to report instances of a received signal fading below a certain threshold. Thus, the broadcast control value(s) may indicate whether access terminals are to log and/or report at least one specified type of radio event, where a specified type may include, for example, radio link failure, signal fading, or call drops.

Either logging or reporting, of all or particular events, could be probabilistic, with a probability factor sent along with the set of flags. In some cases, this technique may be used to enable individual access points to control their load from MDT reports. For example, reporting load may be reduced during busy hours on the theory that a large population of access terminals will have “representative reporters” well distributed over the cell area.

In some aspects, a probability factor may be used to determine the probability of activation of measurement functions, logging functions, reporting functions, or a combination of these functions. In other words, a probability factor may indicate a probability with which an access terminal is to measure a radio event, log a radio event, or report a radio event. As an example of a probability factor value, an access point may use a probability factor to instruct its access terminals to log and/or report radio events 10% of the time. In such a case, each access terminal may then determine whether to log and/or report a given event (e.g., based comparison of a randomly generated number with the probability factor).

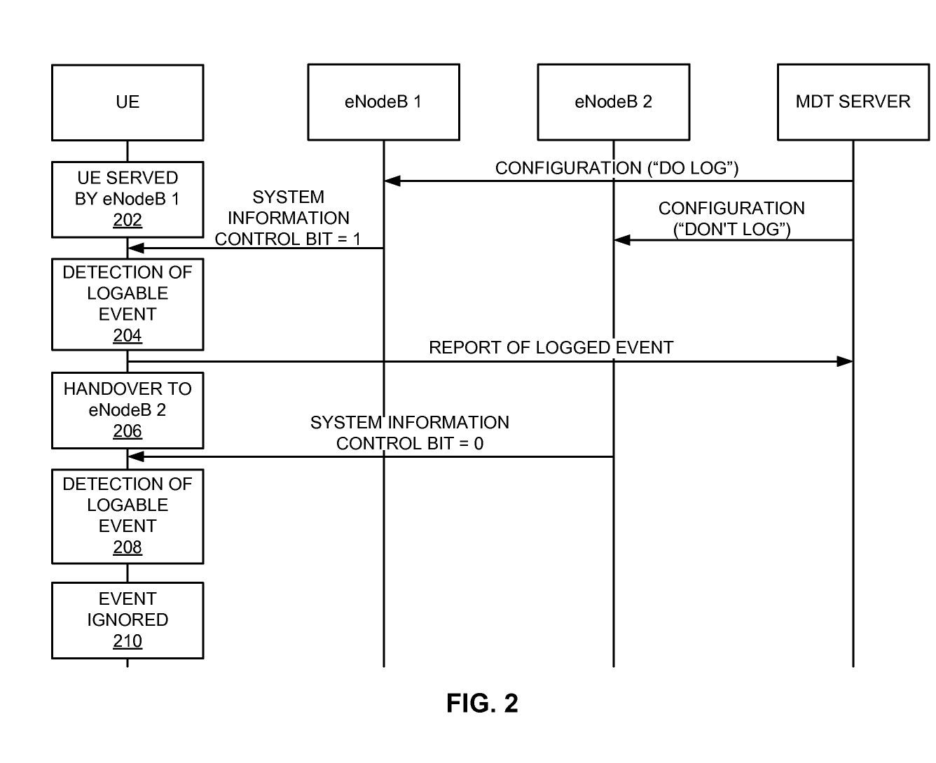

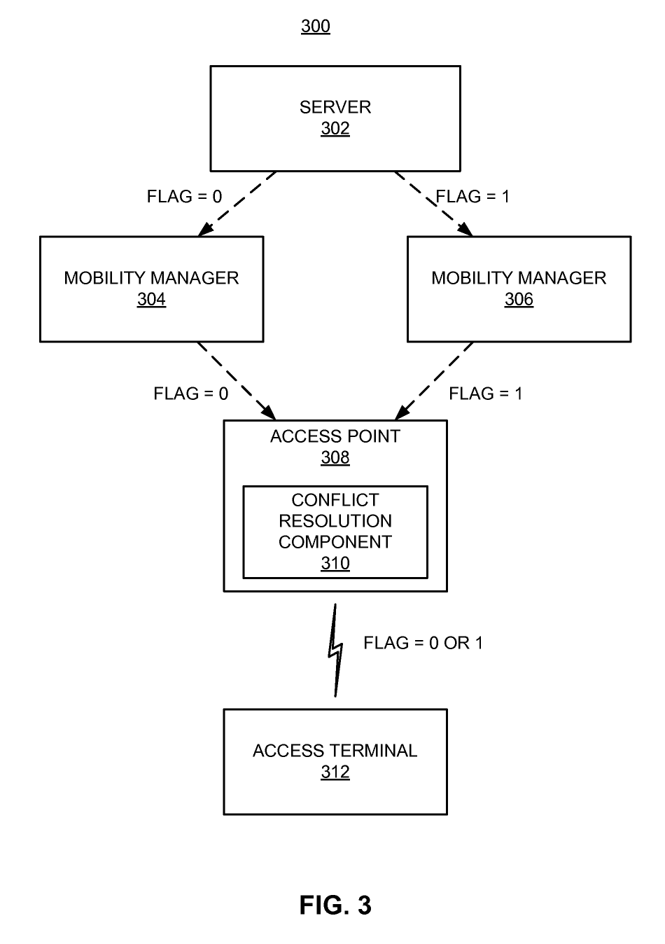

Radio event handling in accordance with the teachings herein may be controlled in various ways and implemented using a variety of architectures. FIGS. 2 and 3 describe sample operations and architectures that may be employed to provide such radio event handling.

FIG. 2 illustrates an example of an implementation (e.g., an LTE-based network) where an MDT server sends configuration information to individual eNode Bs, and where each eNode B broadcasts system information including control bits for controlling radio event handling at the UEs served by that eNode B. It should be appreciated that the disclosed concepts are applicable to other implementations that are based on other technology.

In this example, the MDT server sends a first configuration message to the eNode B 1 and a second configuration message to the eNode B 2. The first configuration message indicates that access terminals under the eNode B 1 are to log (“do log”) radio events. The second configuration message indicates that access terminals under the eNode B 2 are not to log(“don't log”) radio events.

As represented by block 202, at some point in time, a UE is served by the eNode B 1. Accordingly, the UE will receive the system information broadcast by the eNode B 1. In this case, the system information includes a control bit=1, thereby indicating that UEs served by the eNode B 1 are to log radio events.

As represented by block 204, if a loggable event is subsequently detected at the UE, the UE logs that event. The UE may then report any logged events back to the MDT server (e.g., via the eNode B 1). As discussed above, the reporting of logged events may be enabled together with the enablement of logging, or these actions may be enabled separately (e.g., based on separate configuration messages and control bits).

As represented by block 206, at some point in time, the UE is handed-over from the eNode B 1 to the eNode B 2. Consequently, the UE will now receive the system information broadcast by the eNode B 2. In this case, the system information includes a control bit=0, thereby indicating that UEs served by the eNode B 2 are not to log radio events. Thus, if a loggable event is subsequently detected at the UE (block 208), the UE ignores that event (block 210).

The many-to-one relationship of access points (e.g., eNode Bs) to the server may be difficult to manage logistically in the network. With this in mind, the server may instead deliver instructions to access points via network entities that manage sets of access points. An example of such a network entity is a mobility manager (e.g., an MME in an LTE network). A mobility manager may control the system information transmitted by individual access points under its control by conducting individual transactions with the access points via a mobility manager to access point interface (e.g., over the S1 interface in LTE). Advantageously, in such a scheme, existing load-regulation mechanisms for that interface may be employed to manage the transactions in the event there is relatively high transaction volume. However, in such a scheme, control may exist only at the granularity of areas or zones known to the mobility manager (e.g., individual tracking areas in an LTE system). For example, a server may only be able instruct a mobility manager to tell all the access points associated with a certain area or zone (as opposed to individual access points) to broadcast a specified control value.

FIG. 3 illustrates an example of an implementation where a server 302 (e.g., an MDT server) sends configuration information (e.g., including one or more flags) to mobility managers 304 and 306, and where each mobility manager sends configuration information (e.g., including the flag(s)) to the access points associated with that mobility manager. As mentioned above, the server 302 may control access terminal event handling on a tracking area basis, on a location area basis, or on some other basis that depends on the granularity with which the mobility manager allows network entities to reference the access points served by the mobility manager 304. For example, the server 302 may send a configuration message to the mobility manager 304 that indicates that all access terminals served by access points belonging to a specific tracking area shall enable or disable radio event logging and/or reporting. In this case, the mobility manager 304 sends configuration information to each of a set of access points (e.g., the access point 308) belonging to that tracking area. Each of these access points will then broadcast control values to control radio event handling at access terminals (e.g., the access terminal 312) served by that access point.

In implementations where control is given to individual mobility managers, the messaging flow (e.g., the flags) of FIG. 3 illustrates an issue that may arise due to the many-to-many nature of the mobility manager to access point interface. In practice, different mobility managers may manage overlapping sets of access points. However, this information may not be known by the server 302. Consequently, a given access point may receive conflicting instructions from different mobility managers. For example, based on a decision that network conditions in a certain area need to be tested (while silencing testing in another area to reduce the reporting load), the server 302 may instruct the mobility manager 304 to set a flag=0 and instruct the mobility manager 304 to set the flag=1. However, both of these mobility managers may be managing the access point 308. Consequently, the access point may receive configuration information with a flag=0 from the mobility manager 304 and receive configuration information with a flag=1 from the mobility manager 306.

One way to address this issue is to assign the responsibility for avoiding this conflict to the server. That is, imposing a restriction that mobility managers with overlap in their access point pool areas must never be given conflicting instructions. Such a restriction may be undesirable, however, especially if control over an entire pool area's worth of access points is desired for the server.

FIG. 3 illustrates a more robust scheme for resolving such a conflict. Here, the access point 308 includes a conflict resolution component 310 that implements an algorithm (e.g., a heuristic) for resolving any conflicts that may arise. Several examples of algorithms that may be employed here follow.

In some implementations, a majority rule algorithm is employed. For example, an access point may count the number of “1” values and “0” values that it receives (e.g., via in the configuration information) for a given flag. The access point may then identify the value that is in the majority (e.g., select “1” if there are two “1s” and one “0”). The access point may then select at least one control value based on the identified value (e.g., set the corresponding parameter in its system information to the identified value).

In some implementations, an “or of the downs” algorithm is employed. For example, if any mobility manager instructs the access point to set a flag to “0”, the access point will do so irrespective of any instruction to the contrary (e.g., instructions to set the flag to “1”) that the access point receives from any other mobility managers. Thus, in some aspects, the resolution of a conflict may involve setting at least one control value to disable a radio event handling function if any received configuration values indicate that the radio event handling function is to be disabled.

In some aspects, such an approach may mitigate the risk of an overloaded node being unable to throttle the flow of reports (e.g., if the mobility manager is permitted to set the flag to “0” to reduce S1 congestion). The severity of such an issue may depend, for example, on routing decisions about the delivery of reports to the server.

In some implementations, an “or of the ups” algorithm is employed. For example, if any mobility manager instructs the access point to set a flag to “1”, the access point will do so irrespective of any instruction to the contrary (e.g., instructions to set the flag to “0”) that the access point receives from any other mobility managers. In some aspects, this approach may ensure that reports are always sent if any mobility manager (in proxy for the server) requested them. Thus, in some aspects, the resolution of a conflict may involve setting at least one control value to enable a radio event handling function if any received configuration values indicate that the radio event handling function is to be enabled.

An access point-based conflict resolution scheme also may be employed in cases that employ more complex control values. For example, such a scheme may employ probability factors as discussed herein.

As one example, the access point may calculate the value to be broadcast as a function (e.g., calculate an average) of the values received from the different mobility managers. Thus, in some aspects, the resolution of a conflict may involve determining a function (e.g., an average) of a set of received configuration values, and setting at least control value to the determined function of the configuration values.

As another example, the access point may select the minimum value that was received from the different mobility managers. Thus, in some aspects, the resolution of a conflict may involve determining a minimum of a set of received configuration values, and setting at least control value to the determined minimum configuration value.

As yet another example, the access point may select the maximum value that was received from the different mobility managers. Thus, in some aspects, the resolution of a conflict may involve determining a maximum of a set of received configuration values, and setting at least control value to the determined maximum configuration value.

To support the transfer of configuration information between network entities as discussed herein, a configuration protocol may be defined between the server and the radio network and/or core network entities (e.g., mobility managers or access points) with which it communicates. In some aspects, such a protocol enables the server to configure these network entities (e.g. nodes) with one or more values to be used by the network entities for controlling measurement, logging, and reporting functions in access terminals associated with these network entities.

In a very simple implementation of such a protocol, the protocol may only provide a single operation such as the setting of a value (e.g., one of the flags discussed above). In this case, the protocol may comprise a single standardized primitive between the server and the configured network entity. Taking as its arguments an identifier for the value to be configured and a value to be set (or a “delete” indicator to signal that the value should no longer be considered by the network entity to be configured at all).

In a more robust protocol implementation, the protocol may have the ability to start and stop operations by (all access terminals served by) a network entity and/or provide other radio event handling-related functionality. For example, the protocol may include a mechanism for enabling and disabling at least one of: measurement functions, logging functions, or reporting functions.

In any case, the same protocol used for communicating from the server to a network entity may be used in the opposite direction. For example, the protocol may provide a mechanism for the delivery of measured and/or logged information from the configured network entity to the server.

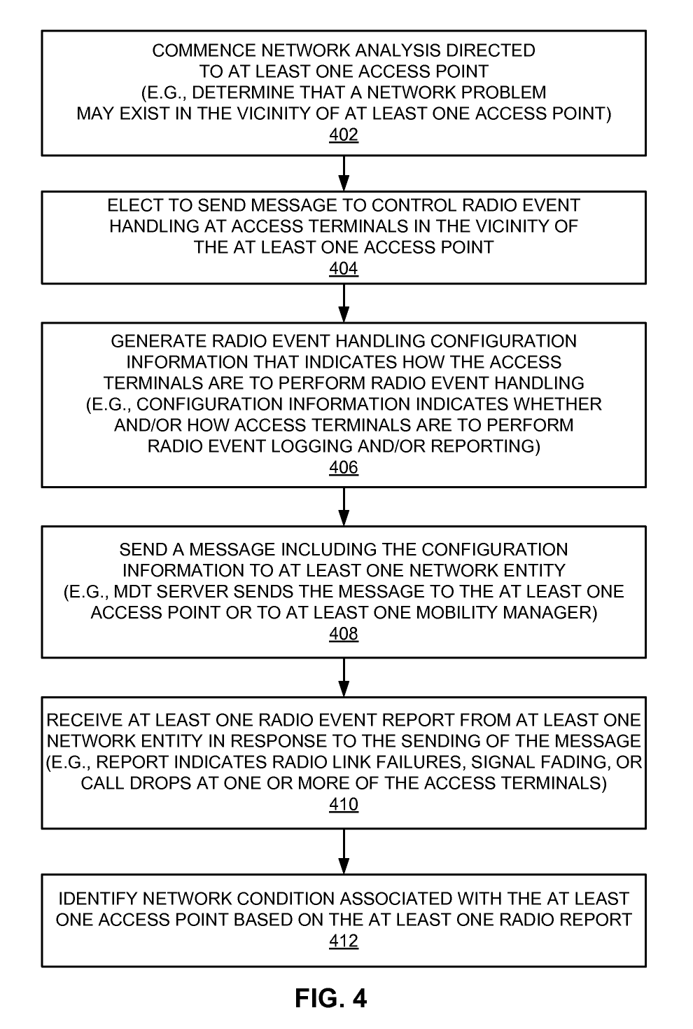

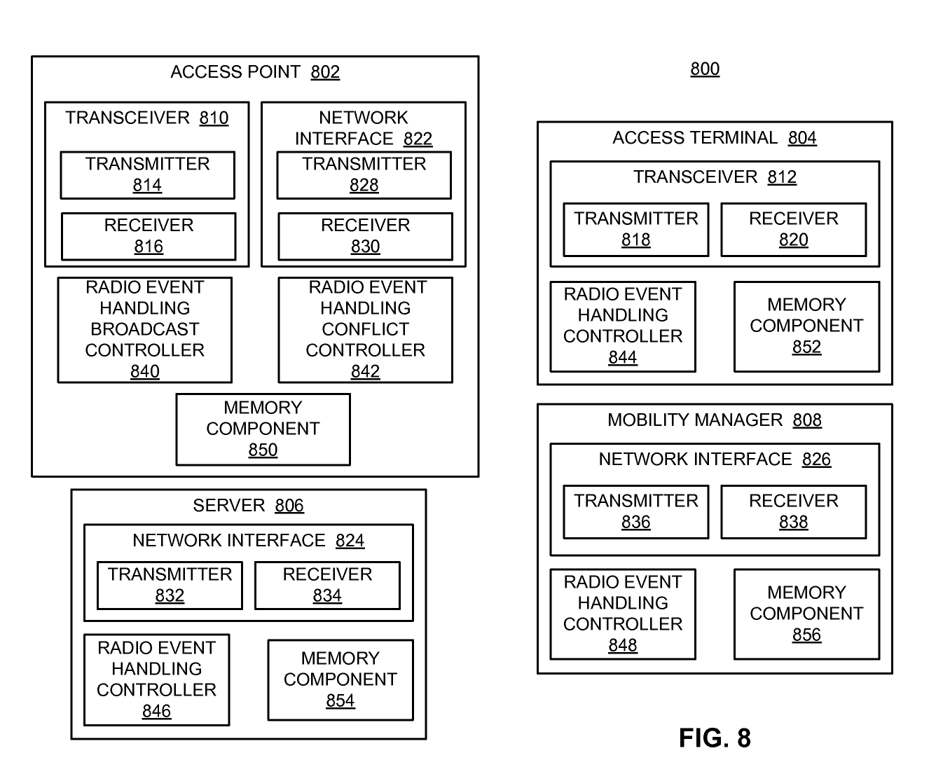

With the above in mind, additional details that may be performed by various entities in a wireless network to enable the control of access terminal event handling through the use of broadcast control values to will be described in conjunction with the flowcharts of FIGS. 4-7. For convenience, the operations of FIGS. 4-7 (or any other operations discussed or taught herein) may be described as being performed by specific components (e.g., components of FIG. 1, FIG. 2, FIG. 3, and FIG. 8). It should be appreciated, however, that these operations may be performed by other types of components and may be performed using a different number of components. It also should be appreciated that one or more of the operations described herein may not be employed in a given implementation.

FIG. 4 describes sample operations that may be performed by one or more network entities (e.g., one or more servers such as an MDT server) that manage radio event handling in a network. Such a network entity may perform various operations including, for example, performing network analysis to determine whether the network is operating efficiently, to determine whether there are problems in the network, and so on. Such a network entity may perform or cooperate with another network entity to perform operations such initiating network testing and analyzing reports that are generated based on this network testing. Such a network entity also may perform or cooperate with another network entity to perform operations such determining network conditions based on the generated reports.

For convenience, the discussion that follows will refer to operations of a network entity. It should be appreciated that these operations may be performed by action of more than one network entity in some implementations.

As represented by block 402, at some point in time, network analysis operations directed to a specific access point or several specific access points are commenced at a network entity. For example, a determination may have been made that a network problem may exist in the vicinity of at least one access point (or at least one cell). Accordingly, it may be decided that access terminals in that vicinity are to log and report radio events.

These decisions may be made in various ways. In some cases, a decision to have access terminals commence logging and/or reporting operations may be made at the behest of network operator personnel (e.g., who may be monitoring network conditions). In some cases, a decision to have access terminals commence logging and/or reporting operations may be made by the network entity (e.g., as a result of automated network operations performed by the network entity or some other entity).

As represented by block 404, as a result of the determination of block 402, the network entity elects to send a message to control radio event handling at access terminals in the vicinity of at least one access point. Accordingly, as represented by block 406, the network entity generates radio event handling configuration information that indicates how the access terminals are to perform radio event handling. For example, as discussed herein, this configuration information may indicate whether the access terminals are to perform radio event logging and/or reporting. In some cases, this configuration information may indicate whether the access terminals are to log and/or report at least one specified type of radio event (e.g., where the specified type may include radio link failure, signal fading, or call drops). In addition, in some cases, this configuration information may indicate how the access terminals are to perform radio event logging and/or reporting. For example, the configuration information may specify which radio events are to be logged and/or reported. In addition, the configuration information may comprise a probability factor that indicates (e.g., specifies) the probability with which the access terminals are to log and/or report a radio event. In some implementations, the configuration information may comprise the control values (e.g., control bits) that are to be broadcast by the at least one access point.

As represented by block 408, the network entity sends a message including the configuration information to at least one network entity. As discussed herein, in some implementations, the network entity sends a message including the configuration information directly to each access point. That is, the destination for each message is an access point.

In other implementations, the network entity sends a message including the configuration information to one or more other network entities (e.g., mobility managers) that manage access points. In this case, the destination for each message is one of these network entities. Here, the configuration information may specify a zone or area (e.g., a tracking area) for which the configuration information is intended. In addition, in some cases, the configuration information comprises a command that indicates that any access points associated with this zone or area are to broadcast at least one control value as taught herein.

As represented by block 410, the network entity may receive at least one radio event report from the network entity (or entities) to which the message of block 408 was sent. For example, upon receiving a radio event report from one of its access terminals, an access point may forward the radio event report to the MDT server. As another example, upon receiving a radio event report from one of its access points (e.g., as a result of the access point receiving a radio event report from one of its access terminals), a mobility manager may forward the radio event report to the MDT server.

In some aspects, the information included in a radio event report may depend on the configuration information sent at block 408. For example, if logging and reporting of all types of radio events has been enabled, a radio event report may include information that indicates whether radio link failures, signal fading, call drops, and other radio events occurred at one or more access terminals. In addition, the information may indicate when and how many times these events occurred.

As represented by block 412, in some implementations, the network entity may identify a network condition associated with the at least one access point based on the at least one radio report. For example, the network entity may determine whether adequate resources or excess resources are allocated in the vicinity of a given access point (or cell).

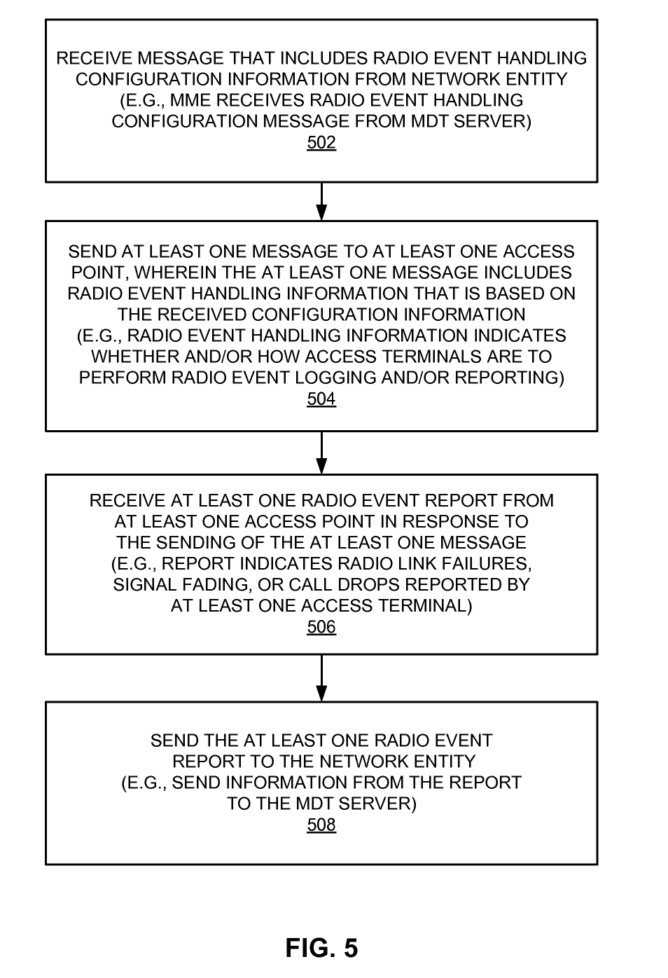

FIG. 5 describes sample operations that may be performed by a network entity (e.g., a mobility manager) that is associated with a set of access points in a network and that provides a mechanism for a server to control radio event handling at the access terminals served by these access points.

As represented by block 502, at some point in time, the network entity receives a message that includes radio event handling configuration information. For example, as discussed above, a mobility manager may receive this configuration information from an MDT server. As mentioned above, this message also may include an indication of the zone or area (e.g., location area) to which the message is directed.

As represented by block 504, as a result of receiving the message at block 502, the network entity (e.g., the mobility manager) sends a message to at least one access point to cause the at least one access point to broadcast at least one control value. As discussed herein, the network entity sends the message to access points associated with the network entity (e.g., the access points that belong to the designated tracking area).

In some aspects, this message includes radio event handling information that is based on the radio event handling configuration information received at block 502. For example, in some cases, the network entity may simply forward the received configuration information (e.g., control values). In other cases, the network may generate new information (e.g., provide a new format) from the received configuration information. In some aspects, the information sent at block 504 indicates how access terminals (e.g., that receive at least one control value for radio event handling broadcast by an access point) are to perform radio event handling. For example, this information may indicate whether access terminals are to log and/or report radio events (e.g., of a specified type). In some cases, the information sent at block 504 comprises the control values (e.g., control bits) that are to be broadcast by at least one access point. In some cases, the information sent at block 504 comprises a probability factor as taught herein.

As represented by block 506, the network entity (e.g., the mobility manager) may receive at least one radio event report from the access point (or access points) to which the message of block 504 was sent. For example, the network entity may receive a radio event report from one of its access points as a result of that access point receiving a radio event report from one of its access terminals.

As represented by block 508, as a result of receiving the at least one radio event report at block 506, the network entity (e.g., the mobility manager) sends at least one radio event report to the network entity (e.g., the MDT server) that sent the message of block 502. In some cases, this may simply involve the mobility manager forwarding the received radio event report to the MDT server. In other cases, the mobility manager may process the received report. For example, the mobility manager may extract information from the received report, optionally process this information (e.g., format the information), and then send the information to the MDT server via a radio event report.

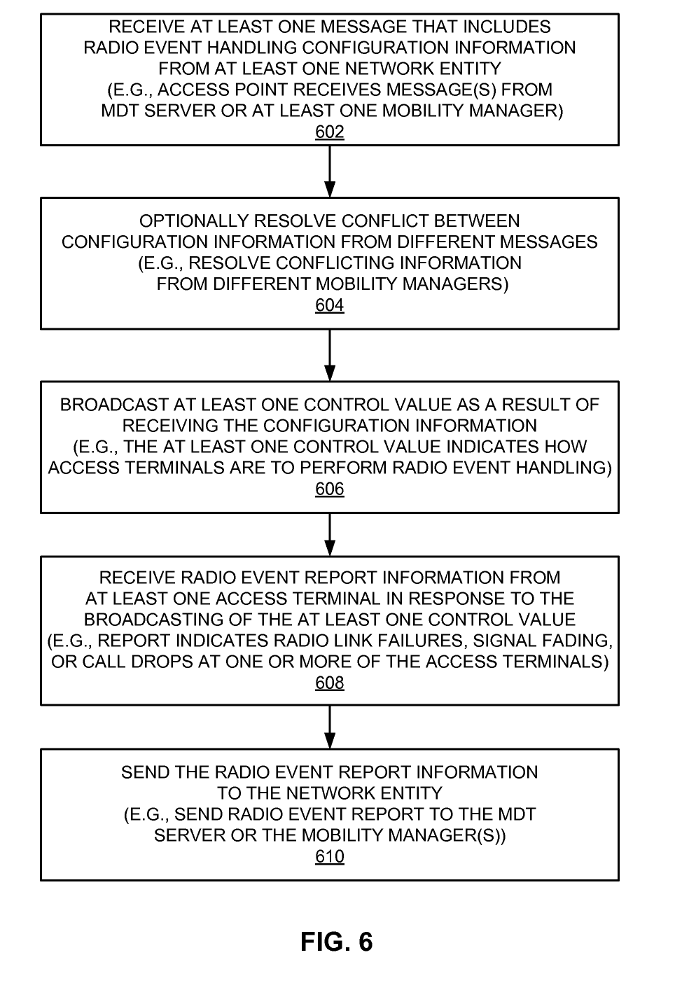

FIG. 6 describes sample operations that may be performed by a network entity (hereafter referred to as an access point) that broadcasts control values (e.g., control bits, probability factors, and so on) for controlling radio event handling at access terminals served by the access point.

As represented by block 602, at some point in time, the access point receives a message that includes radio event handling configuration information from at least one other network entity. For example, as discussed above, an access point may receive this configuration information from an MDT server or from a mobility manager.

As represented by block 604, in cases where configuration information is received from several mobility managers, the access point may resolve any conflicts between the configuration information from different messages. These operations may thus correspond to the conflict resolution operations described above at FIG. 3.

As represented by block 606, the access point broadcasts at least one control value as a result of receiving the configuration information. As discussed herein, in some aspects, the at least one control value indicates how the access terminals that receive the at least one control value are to perform radio event handling.

Here, it should be appreciated that the broadcasting of the at least control value (e.g., transmitting the control value(s) on at least one broadcast channel) involves sending out the information over-the-air without specifying a particular destination. In other words, the at least one control value is not transmitted to a specific access terminal (e.g., via a dedicated channel).

As a specific example, an access point may broadcast system information that includes control values that specify whether radio event logging and/or reporting are to be enabled. In accordance with conventional practice, an access terminal transmits system information on one or more broadcast channels. In some aspects, this system information comprises fundamental configuration information about the access point. For example, system information may include a cell identifier of the access point, power control parameters of the access point, parameters for controlling idle mode functionality, a list of neighboring cells, and so on. In accordance with the teachings herein, an additional field or additional fields may be added to the system information for carrying the radio event handling control values.

As represented by block 608, the access point may receive at least one radio event report from at least one access terminal as a result of broadcasting the control value(s) at block 606. For example, the access point may receive a radio event report from one of the access terminals idling on the access point.

In some aspects, the radio event report information included in a radio event report may depend on the control value(s) broadcast at block 606. For example, if logging and reporting of all types of radio events has been enabled by the broadcast control value(s), a radio event report may include information that indicates whether radio link failures, signal fading, call drops, and so forth occurred at one or more access terminals. In addition, the information may indicate when and how many times these events occurred.

As represented by block 610, as a result of receiving the at least one radio event report at block 608, the access point sends at least one radio event report to the other network entity (e.g., an MDT server or a mobility manager) that sent the message of block 602. In some cases, the access point may simply forward the received radio event report to the other network entity. In other cases, the access point may process the received report. For example, the access point may extract information from the received report, optionally process this information (e.g., format the information), and then send this radio event report information to the other network entity via a radio event report.

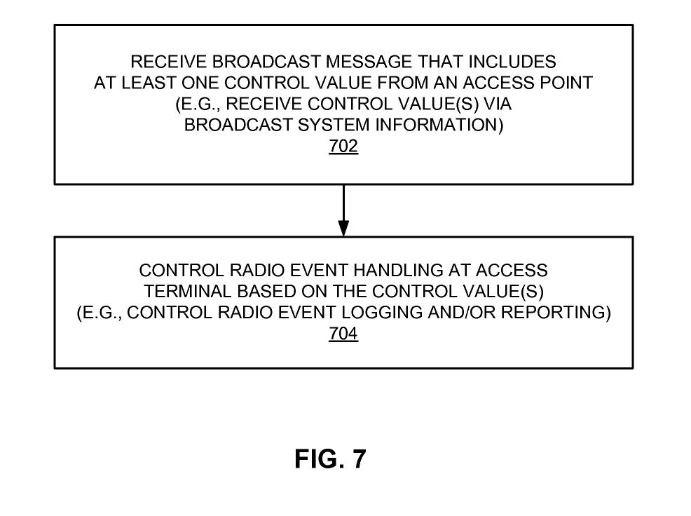

FIG. 7 describes sample operations that may be performed by an access terminal (e.g., a UE, a mobile station, etc.) that controls radio event handling based on broadcast control values that are received by the access terminal.

As represented by block 702, at some point in time, the access terminal receives a broadcast message that includes at least one control value from an access point. For example, an access terminal idling on an access point may periodically wake-up to monitor one or more broadcast channels of the access point. As mentioned above, in some implementations, the access terminal receives the at least one control value via system information broadcast by the access point.

As represented by block 704, the access terminal controls its radio event handling based on the received control value(s). As discussed herein, the controlling of radio event handling may include, for example, controlling logging of radio events and/or controlling reporting of radio events. For example, if a control value indicates that radio event logging and reporting are to be commenced, the access terminal may log radio events, generate radio event reports based on the logged radio events, and send the radio event reports to the access point. In some cases, the at least one control value identifies at least one specified type of radio event (e.g., radio link failure, signal fading, call drops, etc.). In some cases, the at least one control value comprises a probability factor that indicates a probability with which a radio event is to be performed. In these cases, the controlling of the radio event handling may include, for example, limiting logging and/or reporting of a radio event according to the probability.

FIG. 8 illustrates several sample components (represented by corresponding blocks) that may be incorporated into nodes such as an access point 802, an access terminal 804, a server 806, and a mobility manager 808 (e.g., corresponding to the access point 104, the access terminal 102, the server 108, and the mobility manager 110 of FIG. 1, respectively) to perform radio event handling-related operations as taught herein. The described components also may be incorporated into other nodes in a communication system. For example, other nodes in a system may include components similar to those described for the server 806 and the mobility manager 808 to provide similar functionality. Also, a given node may contain one or more of the described components. For example, an access terminal may contain multiple transceiver components that enable the access terminal to operate on multiple carriers and/or communicate via different technologies.

As shown in FIG. 8, the access point 802 and the access terminal 804 each include one or more transceivers (as represented by transceiver 810 and transceivers 812, respectively) for communicating with other nodes. Each transceiver 810 includes a transmitter 814 for sending signals (e.g., transmitting messages, broadcasting system information, broadcasting control values, transmitting pilot signals) and a receiver 816 for receiving signals (e.g., messages, radio event report information). Similarly, each transceiver 812 includes a transmitter 818 for sending signals (e.g., messages, reports) and a receiver 820 for receiving signals (e.g., messages, pilot signals).

The access point 802, the server 806, and the mobility manager 808 include network interfaces 822, 824, and 826, respectively, for communicating with other nodes (e.g., other network entities). Each of the network interfaces 822, 824, and 826 may be configured to communicate with one or more network entities via a wire-based or wireless backhaul. In some aspects, the network interfaces 822, 824, and 826 comprise transceiver components (e.g., transmitter and receiver components) configured to support wire-based communication or wireless communication. Accordingly, in the example of FIG. 8, the network interface 822 is shown as including a transmitter 828 for sending signals (e.g., messages, radio event report information) and a receiver 830 for receiving signals (e.g., messages). Similarly, the network interface 824 is shown as including a transmitter 832 for sending signals (e.g., messages) and a receiver 834 for receiving signals (e.g., messages, radio event reports). Also, the network interface 826 is shown as including a transmitter 836 for sending signals (e.g., messages, radio event reports) and a receiver 838 for receiving signals (e.g., messages, radio event reports).

The access point 802, the access terminal 804, the server 806, and the mobility manager 808 also include other components that may be used in conjunction with radio event handling-related operations as taught herein. For example, the access point 802 includes a radio event handling broadcast controller 840 for controlling broadcasts of radio event handling control values (e.g., providing at least one control value to be broadcast, receiving reports, sending reports) and for providing other related functionality as taught herein. In some implementations, functionality of the radio event handling broadcast controller 840 may be implemented in the transceiver 810. The access point 802 also may include a radio event handling conflict controller 842 for resolving conflicting radio event handling configuration information (e.g., resolving a conflict between configuration information received from different network entities, and providing an indication of the resolution of the conflict) and for providing other related functionality as taught herein. The access terminal 804 includes a radio event handling controller 844 for controlling the handling of radio events based on received broadcast information (e.g., controlling radio event handling based on at least one control value, sending reports) and for providing other related functionality as taught herein. The server 806 includes a radio event handling controller 846 for controlling radio event handling (e.g., generating configuration information, determining that a network problem may exist, electing to send a message as a result of a determination that a network problem may exist, identifying a network condition based on at least one radio event report) and for providing other related functionality as taught herein. The mobility manager 808 includes a radio event handling controller 848 for controlling radio event handling (e.g., providing radio event handling information based on received configuration information, receiving reports, sending reports) and for providing other related functionality as taught herein. The access point 802, the access terminal 804, the server 806, and the mobility manager 808 include memory components (e.g., including memory devices) 850, 852, 854, and 856, respectively, for maintaining information (e.g., radio event related information).

For convenience the access point 802, the access terminal 804, the server 806, and the mobility manager 808 are shown in FIG. 8 as including components that may be used in the various examples described herein. In practice, one or more of the illustrated components may not be used in a given implementation. As an example, in some implementations the access point 802 may not include the radio event handling conflict controller 842. As another example, the functionality of the block 846 may be different in an embodiment implemented in accordance with FIG. 2 as compared to an embodiment implemented in accordance with FIG. 3.

The components of FIG. 8 may be implemented in various ways. In some implementations the components of FIG. 8 may be implemented in one or more circuits such as, for example, one or more processors and/or one or more ASICs (which may include one or more processors). Here, each circuit (e.g., processor) may use and/or incorporate data memory for storing information or executable code used by the circuit to provide this functionality. For example, some of the functionality represented by blocks 810 and 822 and some or all of the functionality represented by blocks 840, 842, and 850 may be implemented by a processor or processors of an access point and data memory of the access point (e.g., by execution of appropriate code and/or by appropriate configuration of processor components). Similarly, some of the functionality represented by block 812 and some or all of the functionality represented by blocks 844 and 852 may be implemented by a processor or processors of an access terminal and data memory of the access terminal (e.g., by execution of appropriate code and/or by appropriate configuration of processor components). Some of the functionality represented by block 824 and some or all of the functionality represented by blocks 846 and 854 may be implemented by a processor or processors of a server and data memory of the server (e.g., by execution of appropriate code and/or by appropriate configuration of processor components). Some of the functionality represented by block 826 and some or all of the functionality represented by blocks 848 and 856 may be implemented by a processor or processors of a mobility manager and data memory of the mobility manager (e.g., by execution of appropriate code and/or by appropriate configuration of processor components).

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

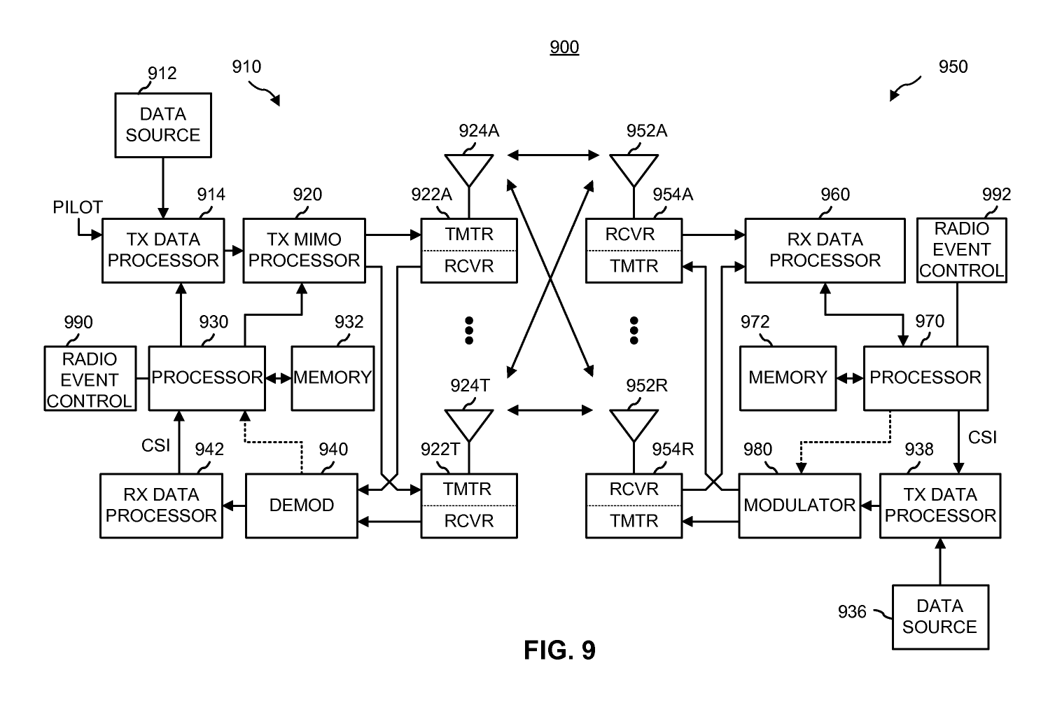

FIG. 9 illustrates a wireless device 910 (e.g., an access point) and a wireless device 950 (e.g., an access terminal) of a sample MIMO system 900. At the device 910, traffic data for a number of data streams is provided from a data source 912 to a transmit (TX) data processor 914. Each data stream may then be transmitted over a respective transmit antenna.

The TX data processor 914 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 930. A data memory 932 may store program code, data, and other information used by the processor 930 or other components of the device 910.

The modulation symbols for all data streams are then provided to a TX MIMO processor 920, which may further process the modulation symbols (e.g., for OFDM). The TX MIMO processor 920 then provides N_{T} modulation symbol streams to N_{T} transceivers (XCVR) 922A through 922T. In some aspects, the TX MIMO processor 920 applies beam-forming weights to the symbols of the data streams and to the antenna from which the symbol is being transmitted.

Each transceiver 922 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 922A through 922T are then transmitted from N_{T} antennas 924A through 924T, respectively.

At the device 950, the transmitted modulated signals are received by N_{R} antennas 952A through 952R and the received signal from each antenna 952 is provided to a respective transceiver (XCVR) 954A through 954R. Each transceiver 954 conditions (e.g., filters, amplifies, and downconverts) a respective received signal, digitizes the conditioned signal to provide samples, and further processes the samples to provide a corresponding “received” symbol stream.

A receive (RX) data processor 960 then receives and processes the N_{R} received symbol streams from N_{R} transceivers 954 based on a particular receiver processing technique to provide N_{T} “detected” symbol streams. The RX data processor 960 then demodulates, deinterleaves, and decodes each detected symbol stream to recover the traffic data for the data stream. The processing by the RX data processor 960 is complementary to that performed by the TX MIMO processor 920 and the TX data processor 914 at the device 910.

A processor 970 periodically determines which pre-coding matrix to use (discussed below). The processor 970 formulates a reverse link message comprising a matrix index portion and a rank value portion. A data memory 972 may store program code, data, and other information used by the processor 970 or other components of the device 950.

The reverse link message may comprise various types of information regarding the communication link and/or the received data stream. The reverse link message is then processed by a TX data processor 938, which also receives traffic data for a number of data streams from a data source 936, modulated by a modulator 980, conditioned by the transceivers 954A through 954R, and transmitted back to the device 910.

At the device 910, the modulated signals from the device 950 are received by the antennas 924, conditioned by the transceivers 922, demodulated by a demodulator (DEMOD) 940, and processed by a RX data processor 942 to extract the reverse link message transmitted by the device 950. The processor 930 then determines which pre-coding matrix to use for determining the beam-forming weights then processes the extracted message.

FIG. 9 also illustrates that the communication components may include one or more components that perform radio event control-related operations as taught herein. For example, a radio event control component 990 may cooperate with the processor 930 and/or other components of the device 910 to control radio event handling at another device (e.g., device 950) as taught herein. Similarly, a radio event control component 992 may cooperate with the processor 970 and/or other components of the device 950 to control radio event handling at the device 950 based on signals received from another device (e.g., device 910). It should be appreciated that for each device 910 and 950 the functionality of two or more of the described components may be provided by a single component. For example, a single processing component may provide the functionality of the radio event control component 990 and the processor 930, and a single processing component may provide the functionality of the radio event control component 992 and the processor 970.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1 xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a Node B, an eNode B, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

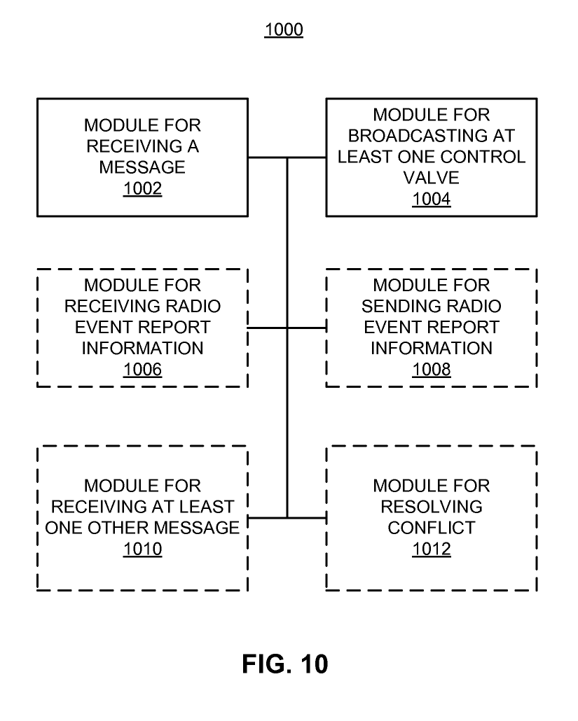

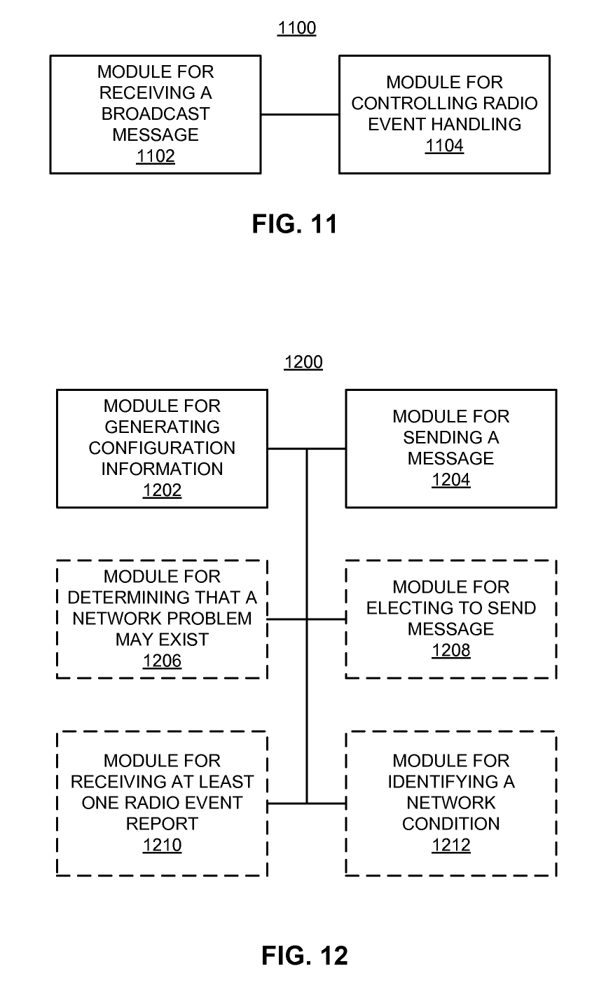

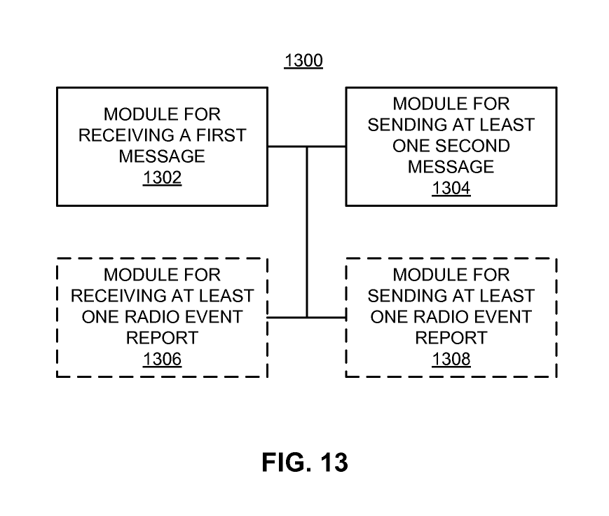

The functionality described herein (e.g., with regard to one or more of the accompanying figures) may correspond in some aspects to similarly designated “means for” functionality in the appended claims. Referring to FIGS. 10-13, apparatuses 1000, 1100, 1200, and 1300 are represented as a series of interrelated functional modules. Here, a module for receiving a message 1002 may correspond at least in some aspects to, for example, a network interface as discussed herein. A module for broadcasting at least one control value 1004 may correspond at least in some aspects to, for example, a transmitter and/or a broadcast controller as discussed herein. A module for receiving radio event report information 1006 may correspond at least in some aspects to, for example, a receiver as discussed herein. A module for sending radio event report information 1008 may correspond at least in some aspects to, for example, a network interface as discussed herein. A module for receiving at least one other message 1010 may correspond at least in some aspects to, for example, a network interface as discussed herein. A module for resolving conflict 1012 may correspond at least in some aspects to, for example, a conflict controller as discussed herein. A module for receiving a broadcast message 1102 may correspond at least in some aspects to, for example, a receiver as discussed herein. A module for controlling radio event handling 1104 may correspond at least in some aspects to, for example, a radio event handling controller as discussed herein. A module for generating configuration information 1202 may correspond at least in some aspects to, for example, a radio event handling controller as discussed herein. A module for sending a message 1204 may correspond at least in some aspects to, for example, a network interface as discussed herein. A module for determining that a network problem may exist 1206 may correspond at least in some aspects to, for example, a radio event handling controller as discussed herein. A module for electing to send a message 1208 may correspond at least in some aspects to, for example, a radio event handling controller as discussed herein. A module for receiving at least one radio event report 1210 may correspond at least in some aspects to, for example, a network interface as discussed herein. A module for identifying a network condition 1212 may correspond at least in some aspects to, for example, a radio event handling controller as discussed herein. A module for receiving a first message 1302 may correspond at least in some aspects to, for example, a network interface as discussed herein. A module for sending at least one second message 1304 may correspond at least in some aspects to, for example, a network interface and/or a radio event handling controller as discussed herein. A module for receiving at least one radio event report 1306 may correspond at least in some aspects to, for example, a network interface as discussed herein. A module for sending at least one radio event report 1308 may correspond at least in some aspects to, for example, a network interface as discussed herein.

The functionality of the modules of FIGS. 10-13 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein. In some aspects one or more of any dashed blocks in FIGS. 10-13 are optional.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. It should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of communication, comprising:
receiving a message from a network entity, wherein the message includes radio event handling configuration information; and
broadcasting at least one control value as a result of receiving the configuration information, wherein the at least one control value indicates how access terminals that receive the at least one control value are to perform radio event handling.

2. The method of claim 1, wherein the broadcasting of the at least one control value comprises transmitting system information including the at least one control value on a broadcast channel of an access point.

3. The method of claim 1, wherein the at least one control value indicates whether the access terminals are to log radio events.

4. The method of claim 1, wherein the at least one control value indicates whether the access terminals are to report radio events.

5. The method of claim 1, wherein the at least one control value indicates whether the access terminals are to: log at least one specified type of radio event, report at least one specified type of radio event, or log and report at least one specified type of radio event.

6. The method of claim 5, wherein the at least one specified type of radio event comprises at least one of the group consisting of: radio link failure, signal fading below a defined threshold, and call drops.

7. The method of claim 1, wherein the at least one control value comprises a probability factor that indicates a probability with which each of the access terminals is to: log a radio event, report a radio event, or log and report a radio event.

8. The method of claim 1, further comprising:
receiving radio event report information from at least one of the access terminals in response to the broadcasting of the at least one control value; and
sending the radio event report information to the network entity.

9. The method of claim 1, wherein the network entity comprises:
a network server that manages radio event reporting, or
a mobility manager for a plurality of access points.

10. The method of claim 1, further comprising:
receiving at least one other message from at least one other network entity, wherein the at least one other message includes other radio event handling configuration information that is in conflict with the radio event handling configuration information received from the network entity; and
resolving the conflict to determine the at least one control value.

11. The method of claim 10, wherein:
the radio event handling configuration information and the other radio event configuration information collectively comprise a plurality of configuration values; and
the resolution of the conflict comprises identifying one of the configuration values as being a majority of the configuration values, and selecting the at least one control value based on the identified configuration value.

12. The method of claim 10, wherein:
the radio event handling configuration information and the other radio event configuration information collectively comprise a plurality of configuration values; and
the resolution of the conflict comprises setting the at least one control value to enable a radio event handling function if any of the configuration values indicate that the radio event handling function is to be enabled.

13. The method of claim 10, wherein:
the radio event handling configuration information and the other radio event configuration information collectively comprise a plurality of configuration values; and
the resolution of the conflict comprises setting the at least one control value to disable a radio event handling function if any of the configuration values indicate that the radio event handling function is to be disabled.

14. The method of claim 10, wherein:
the radio event handling configuration information and the other radio event configuration information collectively comprise a plurality of configuration values; and
the resolution of the conflict comprises determining a minimum of the configuration values, and setting the at least one control value to the determined minimum configuration value.

15. The method of claim 10, wherein:
the radio event handling configuration information and the other radio event configuration information collectively comprise a plurality of configuration values; and
the resolution of the conflict comprises determining a maximum of the configuration values, and setting the at least one control value to the determined maximum configuration value.

16. The method of claim 10, wherein:
the radio event handling configuration information and the other radio event configuration information collectively comprise a plurality of configuration values; and
the resolution of the conflict comprises determining an average of the configuration values, and setting the at least one control value to the determined average of the configuration values.

17. An apparatus for communication, comprising:
a network interface operable to receive a message from a network entity, wherein the message includes radio event handling configuration information;
a broadcast controller operable to provide at least one control value to be broadcast as a result of receiving the configuration information, wherein the at least one control value indicates how access terminals that receive the at least one control value are to perform radio event handling; and
a transmitter operable to broadcast the at least one control value.

18. The apparatus of claim 17, wherein the broadcasting of the at least one control value comprises transmitting system information including the at least one control value on a broadcast channel of an access point.

19. The apparatus of claim 17, wherein the at least one control value indicates whether the access terminals are to log radio events, report radio events, or log and report radio events.

20. The apparatus of claim 19, wherein the radio events comprise at least one of the group consisting of: radio link failure, signal fading below a defined threshold, and call drops.

21. The apparatus of claim 17, further comprising:
a receiver operable to receive radio event report information from at least one of the access terminals in response to the broadcasting of the at least one control value,
wherein the network interface is further operable to send the radio event report information to the network entity.

22. The apparatus of claim 17, wherein:
the network interface is further operable to receive at least one other message from at least one other network entity;
the at least one other message includes other radio event handling configuration information that is in conflict with the radio event handling configuration information received from the network entity; and
the apparatus further comprises a conflict controller operable to resolve the conflict and provide an indication of the resolution of the conflict to the broadcast controller to determine the at least one control value.

23. An apparatus for communication, comprising:
means for receiving a message from a network entity, wherein the message includes radio event handling configuration information; and
means for broadcasting at least one control value as a result of receiving the configuration information, wherein the at least one control value indicates how access terminals that receive the at least one control value are to perform radio event handling.

24. The apparatus of claim 23, wherein the broadcasting of the at least one control value comprises transmitting system information including the at least one control value on a broadcast channel of an access point.

25. The apparatus of claim 23, wherein the at least one control value indicates whether the access terminals are to log radio events, report radio events, or log and report radio events.

26. The apparatus of claim 25, wherein the radio events comprise at least one of the group consisting of: radio link failure, signal fading below a defined threshold, and call drops.

27. The apparatus of claim 23, further comprising:
means for receiving radio event report information from at least one of the access terminals in response to the broadcasting of the at least one control value; and
means for sending the radio event report information to the network entity.

28. The apparatus of claim 23, further comprising:
means for receiving at least one other message from at least one other network entity, wherein the at least one other message includes other radio event handling configuration information that is in conflict with the radio event handling configuration information received from the network entity; and
means for resolving the conflict to determine the at least one control value.

29. A computer-program product, comprising:
computer-readable medium comprising code for causing a computer to:
receive a message from a network entity, wherein the message includes radio event handling configuration information; and
broadcast at least one control value as a result of receiving the configuration information, wherein the at least one control value indicates how access terminals that receive the at least one control value are to perform radio event handling.

30. The computer-program product of claim 29, wherein the broadcasting of the at least one control value comprises transmitting system information including the at least one control value on a broadcast channel of an access point.

31. The computer-program product of claim 29, wherein the at least one control value indicates whether the access terminals are to log radio events, report radio events, or log and report radio events.

32. The computer-program product of claim 31, wherein the radio events comprise at least one of the group consisting of: radio link failure, signal fading below a defined threshold, and call drops.

33. The computer-program product of claim 29, wherein the computer-readable medium further comprises code for causing the computer to:
receive radio event report information from at least one of the access terminals in response to the broadcasting of the at least one control value; and
send the radio event report information to the network entity.

34. The computer-program product of claim 29, wherein:
the computer-readable medium further comprises code for causing the computer to receive at least one other message from at least one other network entity;
the at least one other message includes other radio event handling configuration information that is in conflict with the radio event handling configuration information received from the network entity; and
the computer-readable medium further comprises code for causing the computer to resolve the conflict to determine the at least one control value.

35. A method of communication, comprising:
receiving a broadcast message from an access point at an access terminal, wherein the broadcast message includes at least one control value; and
controlling radio event handling at the access terminal based on the at least one control value.

36. The method of claim 35, wherein the reception of the at least one control value comprises receiving system information including the at least one control value on a broadcast channel of the access point.

37. The method of claim 35, wherein the controlling of the radio event handling comprises controlling logging of radio events.

38. The method of claim 35, wherein the controlling of the radio event handling comprises controlling reporting of radio events.

39. The method of claim 35, wherein:
the at least one control value identifies at least one specified type of radio event; and
the controlling of the radio event handling comprises: controlling logging of the at least one specified type of radio event, controlling reporting of the at least one specified type of radio event, or controlling logging and reporting of the at least one specified type of radio event.

40. The method of claim 39, wherein the at least one specified type of radio event comprises at least one of the group consisting of: radio link failure, signal fading below a defined threshold, and call drops.

41. The method of claim 35, wherein:
the at least one control value comprises a probability factor that indicates a probability with which a radio event is to be performed; and
the controlling of the radio event handling comprises: limiting logging of the radio event accordingly to the probability, limiting reporting of the radio event accordingly to the probability, or limiting logging and reporting the radio event accordingly to the probability.

42. The method of claim 35, wherein the radio event handling comprises:
logging at least one radio event;
generating a radio event report based on the logged at least one radio event; and
sending the radio event report to the access point.

43. An apparatus for communication, comprising:
a receiver operable to receive a broadcast message from an access point at an access terminal, wherein the broadcast message includes at least one control value; and
a controller operable to control radio event handling at the access terminal based on the at least one control value.

44. The apparatus of claim 43, wherein the reception of the at least one control value comprises receiving system information including the at least one control value on a broadcast channel of the access point.

45. The apparatus of claim 43, wherein the controlling of the radio event handling comprises controlling logging of radio events, controlling reporting of radio events, or controlling logging and reporting of radio events.

46. The apparatus of claim 45, wherein the radio events comprise at least one of the group consisting of: radio link failure, signal fading below a defined threshold, and call drops.

47. The apparatus of claim 43, wherein the radio event handling comprises:
logging at least one radio event;
generating a radio event report based on the logged at least one radio event; and
sending the radio event report to the access point.

48. An apparatus for communication, comprising:
means for receiving a broadcast message from an access point at an access terminal, wherein the broadcast message includes at least one control value; and
means for controlling radio event handling at the access terminal based on the at least one control value.

49. The apparatus of claim 48, wherein the reception of the at least one control value comprises receiving system information including the at least one control value on a broadcast channel of the access point.

50. The apparatus of claim 48, wherein the controlling of the radio event handling comprises controlling logging of radio events, controlling reporting of radio events, or controlling logging and reporting of radio events.

51. The apparatus of claim 50, wherein the radio events comprise at least one of the group consisting of: radio link failure, signal fading below a defined threshold, and call drops.

52. The apparatus of claim 48, wherein the radio event handling comprises:
logging at least one radio event;
generating a radio event report based on the logged at least one radio event; and
sending the radio event report to the access point.

53. A computer-program product, comprising:
computer-readable medium comprising code for causing a computer to:
receive a broadcast message from an access point at an access terminal, wherein the broadcast message includes at least one control value; and
control radio event handling at the access terminal based on the at least one control value.

54. The computer-program product of claim 53, wherein the reception of the at least one control value comprises receiving system information including the at least one control value on a broadcast channel of the access point.

55. The computer-program product of claim 53, wherein the controlling of the radio event handling comprises controlling logging of radio events, controlling reporting of radio events, or controlling logging and reporting of radio events.

56. The computer-program product of claim 55, wherein the radio events comprise at least one of the group consisting of: radio link failure, signal fading below a defined threshold, and call drops.

57. The computer-program product of claim 53, wherein the radio event handling comprises:
logging at least one radio event;
generating a radio event report based on the logged at least one radio event; and
sending the radio event report to the access point.
